(19) United States
(12) Patent Application Publication
(10) Pub. No.: US 2007/0236939 A1
(43) Pub. Date: Oct. 11, 2007

(54) Structured Composite Optical Films

(75) Inventors: Andrew J. Ouderkirk, Woodbury, MN (US); Shandon D. Hart, Maplewood, MN (US); Olester Benson JR., Woodbury, MN (US); Patrick R. Fleming, Lake Elmo, MN (US); Kristin L. Thunhorst, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/278,336

(22) Filed: Mar. 31, 2006

(51) Int. Cl. F21V 5/02

(52) U.S. Cl. 362/339

(57) ABSTRACT

Optical films having structured surfaces are used, inter alia, for managing the propagation of light within a display. As displays become larger, it becomes more important that the film be reinforced so as to maintain rigidity. An optical film of the invention has a first layer comprising inorganic fibers embedded within a polymer matrix. The first layer has a structured surface to provide an optical function to light passing therethrough. The film may have various beneficial optical properties, for example, light that propagates substantially perpendicularly through the first layer may be subject to no more than a certain level of haze or light incident on the film may be subject to a minimum value of brightness gain. Various methods of manufacturing the films are described.

### FIELD OF THE INVENTION

The invention relates to optical films and more particularly to optical films having structured surfaces that are used to manage light within a display, for example a liquid crystal display.

### BACKGROUND

Optical films having a structured refractive surface are often used in displays for managing the propagation of light from a light source to a display panel. One illustrative example of such a film is a prismatic brightness enhancing film that is often used to increase the amount of on-axis light from a display.

As display systems increase in size, the area of the films also becomes larger. Such surface-structured films are thin, typically tens or a few hundreds of microns thick and, therefore, have little structural integrity, especially when used in larger display systems. For example, while a film of a certain thickness may be sufficiently rigid for use in a cell phone display, that same film may well be insufficiently rigid for use in a larger display such as a television or computer monitor, without some additional means of support. Stiffer films should also make large display system assembly processes less laborious and potentially more automated, reducing the final assembled cost of the display.

The surface-structured film can be made to be thicker, in order to provide additional rigidity, or may be laminated to a thick polymer substrate to provide the support needed for use in a large area film. The use of a thick film or a thick substrate, however, increases the thickness of the display unit, and also leads to increases in the weight and in the optical absorption. The use of a thicker film or substrate also increases thermal insulation, reducing the ability to transfer heat out of the display. Furthermore, there are continuing demands for displays with increased brightness, which means that more heat is generated with the display systems. This leads to an increase in the distorting effects that are associated with higher heating, for example film warping. In addition, the lamination of the surface-structured film to a substrate adds cost to the device, and makes the device thicker and heavier. The added cost does not, however, result in a significant improvement in the optical function of the display.

### SUMMARY OF THE INVENTION

One embodiment of the invention is directed to an optical film that has a first layer comprising inorganic fibers embedded within a polymer matrix. The first layer has a structured surface. Light that propagates substantially perpendicularly through the first layer is subject to a bulk haze of less than 30%.

Another embodiment of the invention is directed to a display system that has a display panel, a backlight and a reinforced film positioned between the display panel and the backlight. The reinforced film has a structured surface, and is formed of a polymer matrix with inorganic fibers embedded within the polymer matrix. Light that propagates substantially perpendicularly through the reinforced film is subject to a bulk haze of less than 30%.

Another embodiment of the invention is directed to an optical film that comprises a first layer. The first layer comprises inorganic fibers embedded within a polymer matrix and has a structured surface. The first layer provides a brightness gain of at least 10% to light that propagates through the first layer.

Another embodiment of the invention is directed to a method of manufacturing an optical film. The method includes providing a molding tool having a structured surface and providing a fiber reinforced layer comprising inorganic fibers embedded within a matrix formed of at least one of a polymer and a monomer. The fiber reinforced layer is continuously molded against the molding tool to produce a fiber reinforced, structured surface sheet.

Another embodiment of the invention is directed to an optical film that includes a first layer having inorganic fibers embedded within a polymer matrix. The first layer has a structured surface. Single pass transmission for light, substantially normally incident on a side of the first layer facing away from the structured surface, is less than 40%.

The above summary of the present invention is not intended to describe each illustrated embodiment or every implementation of the present invention. The following figures and the detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a display system that uses a surface-structured film according to principles of the present invention;

FIG. 2 schematically illustrates an exemplary embodiment of a fiber reinforced surface-structured film, according to principles of the present invention;

FIG. 3 schematically illustrates an exemplary embodiment of a manufacturing system that may be used for fabricating optical films according to principles of the present invention;

FIGS. 4A-4E schematically illustrate exemplary embodiments of integrally reinforced, surface-structured optical films according to principles of the present invention;

FIG. 5 schematically illustrates an exemplary embodiment of a fiber-reinforced surface-structured film attached to a second layer, according to principles of the present invention;

FIG. 6 schematically illustrates another exemplary embodiment of a fiber-reinforced surface-structured film attached to a second layer, according to principles of the present invention;

FIG. 7 schematically illustrates an exemplary embodiment of a fiber-reinforced surface-structured film attached to two other layers, according to principles of the present invention;

FIG. 8 schematically illustrates a partial cross-sectional view of a fiber-reinforced diffractive layer;

FIG. 9 presents a graph showing luminance as a function of horizontal angle for the various examples of reinforced surface-structured film; and

FIG. 10 presents a graph showing luminance as a function of vertical angle for the various examples of reinforced surface-structured film.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is particularly applicable to optical display systems that use one or more optical films. As optical displays, for example liquid crystal displays (LCDs), become larger and brighter, the demands on optical films within the displays become greater. Larger displays require stiffer films, to prevent warping, bending and sagging. Scaling a film's thickness up with its length and width, however, leads to a thicker and heavier film. It is desirable, therefore, that optical films be made stiffer so that they can be used in large displays, without a concomitant increase in thickness. One approach for increasing the stiffness of an optical film is to include reinforcing fibers within the film. Films reinforced with fibers may also be referred to as composite films. In some exemplary embodiments, the fibers are matched in refractive index to the surrounding material of the film so that there is little, or no, scatter of the light passing through the film. In some embodiments it can be particularly advantageous that there is little or no scatter of light within the film when using a structured surface to control the direction of light. For example, prismatic brightness enhancing films increase the on-axis brightness more when the film is essentially scatter-free. Although it may be desirable in many applications that the optical films are thin, e.g. less than ˜0.2 mm, there is no particular limitation to the thickness. In some embodiments it may be desirable to combine the advantages of composite materials and greater thickness, for example creating thick plates used in LCD-TV's that could be 0.2-2 mm thick. For the purposes of this application, the term “optical film” should be considered to include these thicker optical plates or lightguides.

More specifically, this invention is directed to various organic/inorganic optical composites with structured surfaces, where those structured surfaces have some optical function. The structured composites have surface structures that are “integral” with the composite layer, allowing the composite layer and structured surface to be formed simultaneously, if desired. The optical functions of the structured surfaces generally include some light-directing properties. Some examples of useful light directing properties of the structured surfaces include recycling, collimating or light directing, lensing, turning, diffusing, refracting, or reflecting. The structured surface may have utilitarian discontinuities that come in different forms including, but not limited to, the following: regular structures that are curved, e.g. lenses; regular rectilinear structures such as prisms (as in Vikuiti™ Brightness Enhancement Film, produced by 3M Company, St. Paul, Minn.); turning film and random structures, such as a matte or diffusing surface structure.

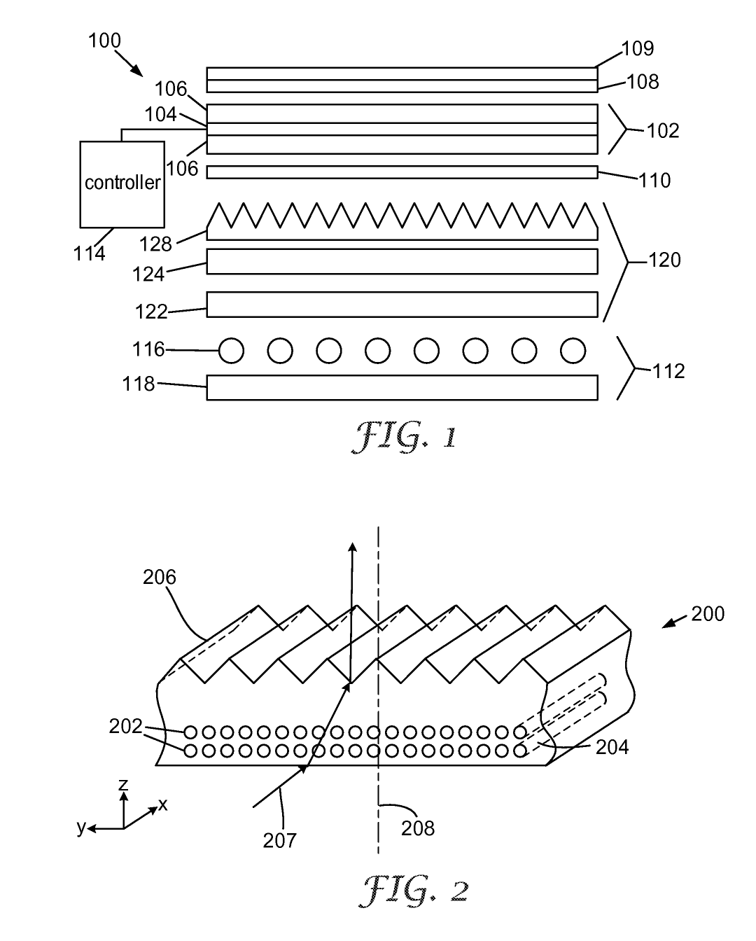

A schematic exploded view of an exemplary embodiment of a display system 100 that may include the invention is presented in FIG. 1. Such a display system 100 may be used, for example, in a liquid crystal display (LCD) monitor or LCD-TV. The display system 100 is based on the use of an LC panel 102, which typically comprises a layer of liquid crystal (LC) 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers 108, 110 are located outside the LC panel 102. The absorbing polarizers 108, 110 and the LC panel 102 in combination control the transmission of light from a backlight 112 through the display system 100 to the viewer.

The backlight 112 includes a number of light sources 116 that generate the light that illuminates the LC panel 102. The light sources 116 used in an LCD-TV or LCD monitor are often linear, cold cathode, fluorescent tubes that extend across the display device 100. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 112 may also include a reflector 118 for reflecting light propagating downwards from the light sources 116, in a direction away from the LC panel 102. The reflector 118 may also be useful for recycling light within the display device 100, as is explained below. The reflector 118 may be a specular reflector or may be a diffuse reflector. One example of a specular reflector that may be used as the reflector 118 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in U.S. Patent Application Publication 2003/0118805 A1, incorporated herein by reference.

An arrangement 120 of light management layers is positioned between the backlight 112 and the LC panel 102. The light management layers affect the light propagating from backlight 112 so as to improve the operation of the display device 100. For example, the arrangement 120 of light management layers may include a diffuser layer 122. The diffuser layer 122 is used to diffuse the light received from the light sources, which results in an increase in the uniformity of the illumination light incident on the LC panel 102. Consequently, this results in an image perceived by the viewer that is more uniformly bright.

The arrangement 120 of light management layers may also include a reflective polarizer 124. The light sources 116 typically produce unpolarized light but the lower absorbing polarizer 110 only transmits a single polarization state, and so about half of the light generated by the light sources 116 is not transmitted through to the LC layer 104. The reflecting polarizer 124, however, may be used to reflect the light that would otherwise be absorbed in the lower absorbing polarizer, and so this light may be recycled by reflection between the reflecting polarizer 124 and the reflector 118. At least some of the light reflected by the reflecting polarizer 124 may be depolarized, and subsequently returned to the reflecting polarizer 124 in a polarization state that is transmitted through the reflecting polarizer 124 and the lower absorbing polarizer 110 to the LC layer 104. In this manner, the reflecting polarizer 124 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers or cholesteric reflective polarizers.

The MOF, cholesteric and continuous/disperse phase reflective polarizers all rely on varying the refractive index profile within a film, usually a polymeric film, to selectively reflect light of one polarization state while transmitting light in an orthogonal polarization state. Some examples of MOF reflective polarizers are described in U.S. Pat. No. 5,882,774, incorporated herein by reference. Commercially available examples of MOF reflective polarizers include Vikuiti™ DBEF-II and DBEF-D400 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in e.g. co-owned U.S. Pat. No. 5,867,316, also incorporated herein by reference. Other suitable types of DRPF are described in U.S. Pat. No. 5,751,388.

Some examples of cholesteric polarizer useful in connection with the present invention include those described, for example, in U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

The arrangement 120 of light management layers may also include a prismatic brightness enhancing layer 128. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic elements that redirect the illumination light, through refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT. The prismatic elements may be formed as ridges that extend across the width of the film, or as shorter elements.

An exemplary embodiment of surface-structured film 200 having integral fiber reinforcement is schematically illustrated in FIG. 2. The reinforced film 200 includes reinforcement fibers 202 embedded within a polymer matrix 204. At least one surface of the matrix 204 is provided with a structured surface 206. In the illustrated exemplary embodiment, the structured surface 206 is a prismatic brightness enhancing surface, having prismatic elements for redirecting light to propagate in a direction close to the display axis.

The inorganic fibers 202 may be formed of glass, ceramic or glass-ceramic materials, and may be arranged within the matrix 204 as individual fibers, in one or more tows or in one or more woven or non-woven layers. The fibers 202 may be arranged in a regular pattern or an irregular pattern. Several different embodiments of reinforced polymeric layers are discussed in greater detail in U.S. patent application Ser. No. 11/125,580, incorporated herein by reference.

In many embodiments of the invention, the composite layer is highly transparent due to refractive index matching between the organic and inorganic components of the composite. The integration of the structured surface with a composite layer reduces the potential for the structured surface warp or bend when used under conditions of elevated temperature.

Furthermore, in the construction of some currently existing surface-structured films, the priming of a base film is critical to ensure good adhesion of the microreplicated surface structure to the base film. In contrast, under certain embodiments of the present invention having an integrated structured composite, the base film and the structured surface can be created from the same resin system. This simplifies the overall fabrication process and eliminates the need for a separate primer layer and priming step. Alternatively, the base film could be a composite made with one resin system while the structured surface could be provided by a second resin system with desirable properties (containing additives, nanoparticles, or having a high refractive index).

Monolithically integrated, surface-structured composites also provide an excellent strategy for maximizing the stiffness-to-thickness ratio of a structured optical film, combining the properties of thinness, stiffness, and low warp which are important properties for certain optical applications. A reduction in film thickness, while maintaining stiffness, is particularly important in handheld and notebook computer displays, but is generally desirable in all display applications due to weight and space-saving concerns.

The refractive indices of the matrix 204 and the fibers 202 may be chosen to match or not match. In some exemplary embodiments, it may be desirable to match the refractive indices so that the resulting article is nearly, or completely, transparent to the light from a light source. In other exemplary embodiments, it may be desirable to have an intentional mismatch in the refractive indices to create either specific color scattering effects or to create diffuse transmission or reflection of the light incident on the film. Refractive index matching can be achieved by selecting an appropriate fiber 202 reinforcement that has an index close to the same as that of the resin matrix 204, or by creating a resin matrix that has a refractive index close to, or the same as, that of the fibers 202.

The refractive indices in the x-, y-, and z-directions for the material forming the polymer matrix 204 are referred to herein as n₁ₓ, n_{1y} and n_{1z}. Where the polymer matrix material 204 is isotropic, the x-, y-, and z-refractive indices are all substantially matched. Where the matrix material is birefringent, at least one of the x-, y- and z-refractive indices is different from the others. The material of the fibers 202 is typically isotropic. Accordingly, the refractive index of the material forming the fibers 202 is given as n₂. The inorganic fibers 202 may, however, be birefringent.

In some embodiments, it may be desired that the polymer matrix 204 be isotropic, i.e. n₁ₓ≈n_{1y}≈n_{1z}≈n₁. Two refractive indices are considered to be substantially the same if the difference between the two indices is less than 0.05, preferably less than 0.02 and more preferably less than 0.01. Thus, the material is considered to be isotropic if no pair of refractive indices differs by more than 0.05, preferably less than 0.02. Furthermore, in some embodiments it is desirable that the refractive indices of the matrix 204 and the fibers 202 be substantially matched. Thus, the refractive index difference between the matrix 204 and the fibers 202, the difference between n₁ and n₂ should be small, at least less than 0.02, preferably less than 0.01 and more preferably less than 0.002.

In other embodiments, it may be desired that the polymer matrix 204 be birefringent, in which case at least one of the matrix refractive indices is different from the refractive index of the fibers 202. In embodiments where the fibers 202 are isotropic, a birefringent matrix 204 results in light in at least one polarization state being scattered by the reinforcing layer. The amount of scattering depends on several factors, including the magnitude of the refractive index difference for the polarization state being scattered, the size of the fibers 202 and the density of the fibers 202 within the matrix 204. Furthermore, the light may be forward scattered (diffuse transmission), backscattered (diffuse reflection), or a combination of both. Scattering of light by a fiber-reinforced layer 200 is discussed in greater detail in U.S. patent application Ser. No. 11/125,580.

Suitable materials for use in the polymer matrix 204 include thermoplastic and thermosetting polymers that are transparent over the desired range of light wavelengths. In some embodiments, it may be particularly useful that the polymers be non-soluble in water, the polymers may be hydrophobic or may have a low tendency for water absorption. Further, suitable polymer materials may be amorphous or semi-crystalline, and may include homopolymer, copolymer or blends thereof. Example polymer materials include, but are not limited to, poly(carbonate) (PC); syndiotactic and isotactic poly(styrene) (PS); C1-C8 alkyl styrenes; alkyl, aromatic, and aliphatic ring-containing (meth)acrylates, including poly(methylmethacrylate) (PMMA) and PMMA copolymers; ethoxylated and propoxylated (meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds. These polymers may be used in an optically isotropic form.

In some product applications, it is important that film products and components exhibit low levels of fugitive species (low molecular weight, unreacted, or unconverted molecules, dissolved water molecules, or reaction byproducts). Fugitive species can be absorbed from the end-use environment of the product or film, e.g. water molecules can be present in the product or film from the initial product manufacturing, or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc.

The fugitive species are generally lower molecular weight than the majority of the material comprising the rest of the functional product or film. Product use conditions might, for example, result in thermal stress that is differentially greater on one side of the product or film. In these cases, the fugitive species can migrate through the film or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

It may be desirable in some embodiments that the polymer matrix of the film 200 be birefringent: several of the polymers named above may become birefringent when oriented. In particular, PET, PEN, and copolymers thereof, and liquid crystal polymers, manifest relatively large values of birefringence when oriented. Polymers may be oriented using different methods, including extrusion and stretching. Stretching is a particularly useful method for orienting a polymer, because it permits a high degree of orientation and may be controlled by a number of easily controllable external parameters, such as temperature and stretch ratio.

It is important to note, however, that structured surface composites may also be made to be substantially non-birefringent. This may be desired in some embodiments because it broadens the possibilities of spatial placement of the structured surface composite within the optical film stack of, for example, a liquid crystal display (LCD). In contrast, some conventional surface structured films may manifest an undesirable birefringence. The substantially optically isotropic characteristics of the surface structured composites described herein may provide flexibility in the design of the optical film stack in a display application.

The matrix 204 may be provided with various additives to provide desired properties to the film 200. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant and a blowing agent.

Some exemplary embodiments may use a polymer matrix material that is resistant to yellowing and clouding with age. For example, some materials such as aromatic urethanes become unstable when exposed long-term to UV light, and change color over time. It may be desired to avoid such materials when it is important to maintain the same color for a long term.

Other additives may be provided to the matrix 204 for altering the refractive index of the polymer or increasing the strength of the material. Such additives may include, for example, organic additives such as polymeric beads or particles and polymeric nanoparticles. In some embodiments, the matrix 204 is formed using a specific ratio of two or more different monomers, where each monomer is associated with a different final refractive index when polymerized. The ratios of the different monomers determine the refractive index of the matrix 204.

In other embodiments, inorganic additives may be added to the matrix 204 to adjust the refractive index of the matrix 204, or to increase the strength and/or stiffness of the material. For example, the inorganic material may be glass, ceramic, glass-ceramic or a metal-oxide. Any suitable type of glass, ceramic or glass-ceramic, discussed below with respect to the inorganic fibers, may be used. Suitable types of metal oxides include, for example, titania, alumina, tin oxides, antimony oxides, zirconia, silica, mixtures thereof or mixed oxides thereof. Such inorganic materials may be provided as nanoparticles, for example milled, powdered, bead, flake or particulate in form, and distributed within the matrix. Nanoparticles may be synthesized, for example, using gas-phase or solution-based processing. The size of the particles is preferably lower than about 200 nm, and may be less then 100 nm or even 50 nm to reduce scattering of the light passing through the matrix 204. The additives may have functionalized surfaces to optimize the dispersion and/or the rheology and other fluid properties of the suspension, or to react with the polymer matrix. Other types of particles include hollow shells, for example hollow glass shells.

Any suitable type of inorganic material may be used for the fibers 202. The fibers 202 may be formed of a glass that is substantially transparent to the light passing through the film. Examples of suitable glasses include glasses often used in fiberglass composites such as E, C, A, S, R, and D glasses. Higher quality glass fibers may also be used, including, for example, fibers of fused silica and BK7 glass. Suitable higher quality glasses are available from several suppliers, such as Schott North America Inc., Elmsford, N.Y. It may be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the film becomes more stable for long term use. Furthermore, it may be desirable to use a low alkali glass, since alkali content in glass increases the absorption of water. Other inorganic materials, for example ceramics or glass-ceramics, may be used for the fiber reinforcement, as is discussed in Ser. No. 11/125,580.

Discontinuous reinforcements, such as particles or chopped fibers, may be desired in polymers that need stretching or certain other forming processes. Extruded thermoplastics filled with chopped glass, for example, as described in U.S. patent application Ser. No. 11 /323,726, incorporated herein by reference, may be used as the fiber reinforced layer. For other applications, continuous glass fiber reinforcements (i.e. weaves, tows or non-wovens) may be used since these can lead to a larger reduction in the coefficient of thermal expansion (CTE) and a greater increase in modulus. These continuous reinforcements are more feasible to incorporate using a saturation/impregnation and curing process rather than an extrusion-based process.

In some exemplary embodiments, it may be desirable not to have perfect refractive index matching between the matrix 204 and the fibers 202, so that at least some of the light is diffused by the fibers 202. In such embodiments, either or both of the matrix 204 and fibers 202 may be birefringent, or both the matrix and the fibers may be isotropic. Depending on the size of the fibers 202, the diffusion arises from scattering or from simple refraction. Diffusion by a fiber is non-isotropic: light may be diffused in a direction lateral to the axis of the fiber, but is not diffused in an axial direction relative to the fiber. Accordingly, the nature of the diffusion is dependent on the orientation of the fibers within the matrix. If the fibers are arranged, for example, parallel to the x-axis, then the light is diffused in directions parallel to the y- and z-axes.

In addition, the matrix 204 may be loaded with diffusing particles that isotropically scatter the light. Diffusing particles are particles of a different refractive index than the matrix, often a higher refractive index, having a diameter up to about 10 μm. These can also provide structural reinforcement to the composite material. The diffusing particles may be, for example, metal oxides such as were described above for use as nanoparticles for tuning the refractive index of the matrix. Other suitable types of diffusing particles include polymeric particles, such as polystyrene or polysiloxane particles, or a combination thereof. The diffusing particles may also be hollow glass spheres such as type S60HS Glass Bubbles, produced by 3M Company, St. Paul, Minn. The diffusing particles may be used alone to diffuse the light, may be used along with non-index-matched fibers to diffuse the light, or may be used in conjunction with the structured surface to diffuse and re-direct light.

Some exemplary arrangements of fibers 202 within the matrix 204 include yarns, tows of fibers or yarns arranged in one direction within the polymer matrix, a fiber weave, a non-woven, chopped fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. Furthermore, the matrix 204 may contain multiple layers of fibers 202: for example the matrix 204 may include more layers of fibers in different tows, weaves or the like. In the specific embodiment illustrated in FIG. 2, the fibers 202 are arranged in two layers.

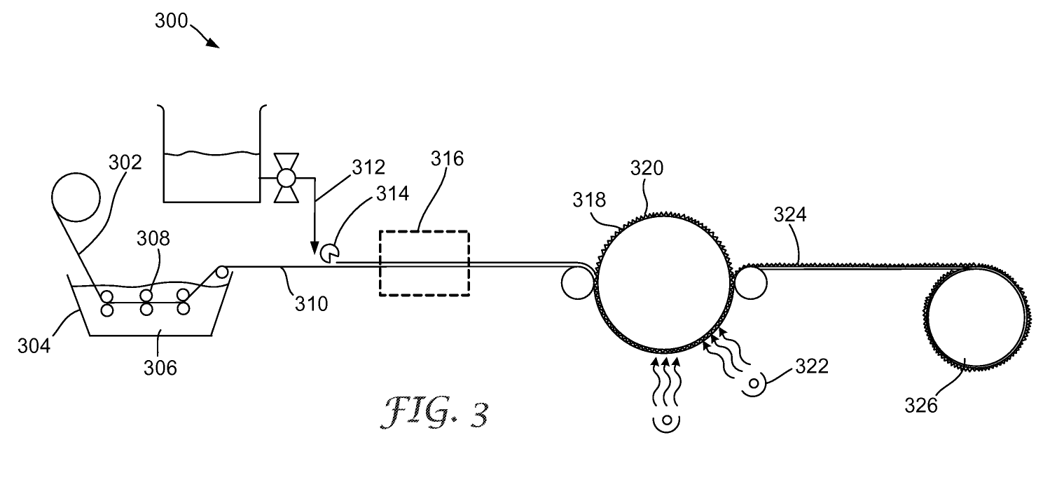

One exemplary approach to manufacturing a reinforced surface-structured film is now described with reference to FIG. 3. In general, this approach includes applying a matrix resin directly to a pre-prepared surface-structured layer. The manufacturing arrangement 300 includes a roll of the fiber reinforcement 302, which is passed through an impregnation bath 304 containing the matrix resin 306. The resin 306 is impregnated into the fiber reinforcement 302 using any suitable method, for example by passing the fiber reinforcement 302 through a series of rollers 308.

Once the impregnated reinforcement 310 is extracted from the bath 304, additional resin 312 may be applied if necessary. The additional resin 312 may be applied over the reinforcement layer 310, for example using a coater 314. The coater 314 may be any suitable type of coater, for example a knife edge coater, comma coater (illustrated), bar coater, die coater, spray coater, curtain coater, high pressure injection, or the like. Among other considerations, the viscosity of the resin at the application conditions determines the appropriate coating method or methods. The coating method and resin viscosity also affect the rate and extent to which air bubbles are eliminated from the reinforcement during the step where the reinforcement is impregnated with the matrix resin.

Where it is desired that the finished film have low scatter, it is important at this stage to ensure that the resin completely fills the spaces between the fibers: voids or bubbles left in the resin may act as scattering centers. Different approaches may be used, individually or in combination, to reduce the occurrence of bubbles. For example, the film may be mechanically vibrated to encourage the dissemination of the resin 306 throughout the reinforcement layer 310. The mechanical vibration may be applied using, for example, an ultrasonic source. In addition, the film may be subject to a vacuum that extracts the bubbles from the resin 306. This may be performed at the same time as coating or afterwards, for example in an optional de-aeration unit 316.

The impregnated reinforced layer 310 may then be applied against a molding roll 318. The layer 310 is held against the structured surface 320 of the molding roll 318 so as to create an impression in the resin. The resin may then be solidified while in contact with the molding roll 318. Solidification includes curing, cooling, cross-linking and any other process that results in the polymer matrix reaching a solid state. In the illustrated embodiment, radiation sources 322 are used to apply radiation to the resin. In other embodiments different forms of energy may be applied to the resin including, but not limited to, heat and pressure, electron beam radiation and the like, in order to solidify the resin 306. In other embodiments the resin 306 may be solidified by cooling, polymerization or by cross-linking. Cooling is a technique that is particularly suited to using thermosetting polymers. For example, the molding roll 318 may be used to cool the resin.

In some embodiments, the solidified film 324 is sufficiently supple as to be collected and stored on a take-up roll 326. In other embodiments, the solidified film 324 may be too rigid for rolling, in which case it is stored some other way, for example the film 324 may be cut into sheets for storage.

Different types of surface structures may be used on the reinforced film. FIG. 2 shows a reinforced film 200 having a brightness enhancing surface 206, which directs off-axis light 207 passing therethrough into a direction that is more parallel to the axis 208. The axis 208 lies normal to the film 200. The light ray 207 may be considered to be a principal ray. In some embodiments, the ray 207 is incident at the film 200 at an angle of more than 30° to the axis 208, and emerges from the film 200 with an angle of less than 25° to the axis. In some embodiments, the direction of the principal ray 207 after being transmitted through the film 200 is more than 5° different from the direction of the principal ray 207 before entering the film 200, in other words the film 200 has deviated the ray 207 through an angle of more than 5°, in some embodiments more than 10° and in some embodiments more than 20°. A brightness enhancing surface is not restricted to only containing prisms with flat sides. In other exemplary embodiments, the sides of the prisms may be curved, or the prisms may not extend the entire width of the film.

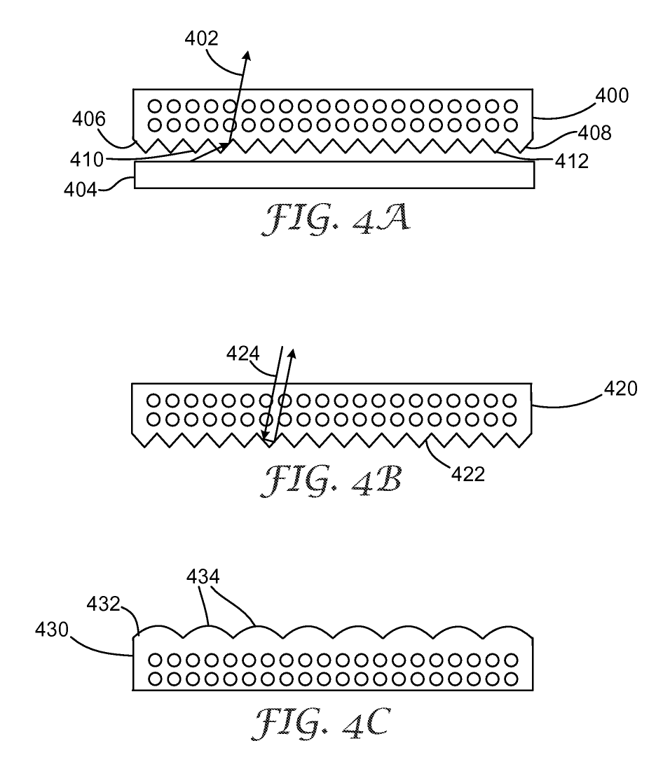

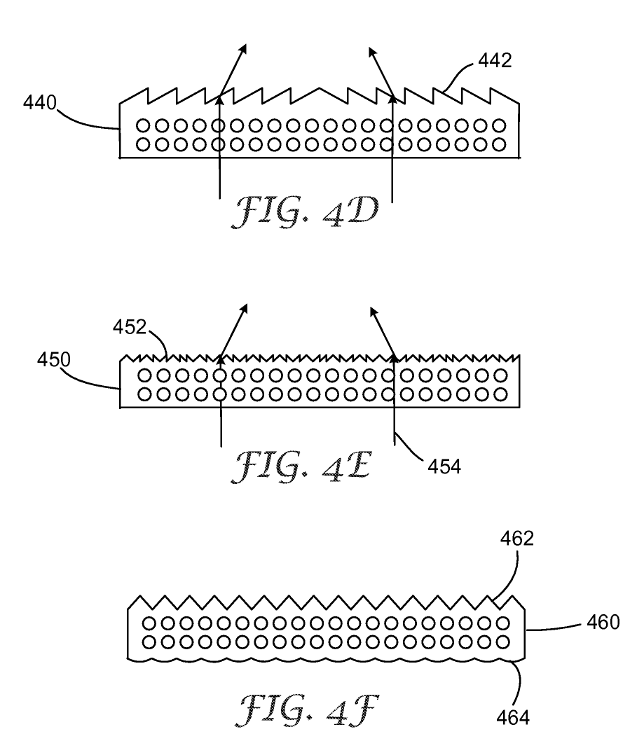

One embodiment of a surface structured reinforced film 400 is schematically illustrated in FIG. 4A. The film 400 is a reinforced turning film, used for turning the direction of light 402 that has passed out of a light guide 404 used in a backlight. Light from a turning film may then pass through one or more additional light management films before being incident on the display panel (not shown). The structured surface 406 includes a number of protrusions 408 having an entry face 410 and a reflecting face 412. The light 402 enters the protrusion through an entry face 410 and is totally internally reflected at a reflecting face 412. The reflecting face 412 may be flat, as illustrated, or may be faceted or curved, or may take on some other shape.

Another embodiment of a surface-structured, reinforced film 420 is schematically illustrated in FIG. 4B. A structured surface 422 includes a number of corner cube reflectors 424 that retroreflect light 426.

Another embodiment of a surface-structured, reinforced film 430 is schematically illustrated in FIG. 4C. In this embodiment, the structured surface 432 includes one or more lenses 434. The lenses 434 may have a positive optical power or negative optical power.

FIG. 4D schematically illustrates another surface-structured reinforced film 440. The film 440 has a structured surface 442 in the form of a Fresnel lens.

FIG. 4E schematically illustrates another surface-structured reinforced film 450. The film 450 includes a diffractive structured surface 452. The diffractive surface 452 may be formed as a diffractive optical element that provides any desired diffractive function to light 454 passing through the film 450. For example, a diffractive surface may be used to focus or defocus light, to direct light in one or more certain directions, to separate light into differently colored components, or to act as a shaped diffuser.

In some exemplary embodiments, a surface-structured reinforced film may include two structured surfaces on opposing faces. An exemplary embodiment of such a dual surface structured film 460 is schematically illustrated in FIG. 4F. The film 460 has a first structured surface 462 and a second structured surface 464. Many different types of structures can provided in combination on the two surfaces 462, 464, including brightness enhancing structures, lens structures, diffusing structures, diffracting structures, turning structures, and retroreflecting structures. In the illustrated embodiment, the upper structured surface 462 is structured with a brightness enhancing structure while the lower structured surface 464 is structured with a lensed surface, which may be a lenticular lensed surface. The structures on each side of the dual surface structured film may be linear, concentric, random, or some other type of pattern. The types of pattern on each side need not be the same.

In some embodiments, one structured surface may be registered to the other structured surface. For example, if the pitch of a repeating brightness enhancing prismatic structure on one side is P, the pitch of the lenses on the other side may be the same, and set so that light from one lens is directed towards one brightness enhancing surface. Such an arrangement is illustrated in FIG. 4F. The structures on the two surfaces need not be registered, however. A dual surface structured film can be manufactured by pressing the film between two molding rolls simultaneously, or by molding one side against a first molding tool and then molding the second side against a second molding tool.

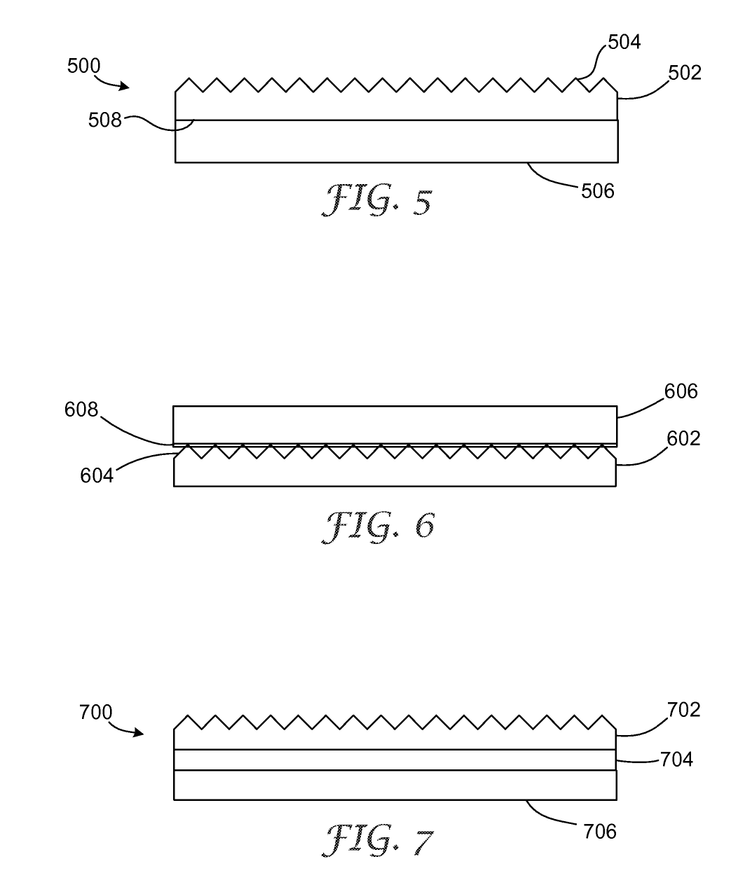

In some exemplary embodiments, a fiber reinforced structured-surface layer may be attached to other layers. FIG. 5 schematically illustrates a surface-structured, reinforced layer 502 attached to a second optical layer 506. In this embodiment, the second optical layer 506 is attached to the side 508 opposite the structured surface 504. The second optical layer 506 may be any suitable type of layer, such as a polarizer layer, a turning layer or the like. The polarizer layer may be any type of polarizer layer, including a reflective polarizer and an absorbing polarizer. The second optical layer 506 may be attached to the structured-surface layer 502 using an adhesive, such as a pressure sensitive adhesive or a laminating adhesive.

In other embodiments, a second optical layer may be attached to the structured surface. One exemplary embodiment is schematically illustrated in FIG. 6, in which a reinforced brightness enhancement layer 602 is attached to a second layer 606. Portions of the structured surface 604 are embedded within a thin adhesive layer 608 that is positioned on the surface of the second layer 606 facing the reinforced layer 602. The attachment of a structured surface to another optical film is discussed in greater detail in U.S. Pat. No. 6,846,089, incorporated herein by reference. Generally, the adhesive layer 608 is relatively thin compared to the height of the surface structure. The structured surface 604 is pressed into the adhesive layer 608 to such a depth as to leave a significant portion of the structured surface 608 interfaced with air. This maintains the relatively large refractive index difference between the air and the layer 602, thus conserving the refractive effects of the structured surface 604. It will be appreciated that the structured surface of other types of surface-structured films may also be attached to a reinforced layer.

Other light management layers may be included for purposes other than brightness enhancement. These uses include spatial mixing or color mixing of light, light source hiding, and uniformity improvement. Films that may be used for these purposes include diffusing films, diffusing plates, partially reflective layers, color-mixing lightguides or films, and diffusing systems in which the peak brightness ray of the diffused light propagates in a direction that is not parallel to the direction of the peak brightness ray of the input light.

The reinforced surface-structure layer may be attached to more than one other layer. For example, optical layers may be attached to both the structured surface and the other surface of the structured surface layer. In another embodiment, more than one other layer may be attached to one of the surfaces of the reinforced structured surface layer. One particular example is schematically illustrated in FIG. 7, in which a second optical layer 704 is attached to a non-structured, e.g. flat, side of a reinforced structured surface layer 702. A third optical layer is attached to the second optical layer. The second and third optical layers 704, 706 may be any desired type of optical layer, including polarizer layers and the like. In addition, either of the second and third layers 704, 706 may be reinforced layers. In one example discussed below, the second optical layer 704 is a reflective polarizer layer and the third optical layer 706 is a flat reinforced layer.

### EXAMPLES

Select embodiments of this invention are described below. These examples are not meant to be limiting, only illustrative of some of the aspects of the invention.

All of the following examples of composite film used as the inorganic fiber reinforcement a woven fiberglass produced by Hexcel Reinforcements Corp., Anderson, S.C. The Hexcel 106 (H-106) fibers were received from the vendor with finish applied to the fibers to act as a coupling agent between the fiber and the resin matrix. In the examples, all the H-106 glass fabrics used had a CS767 silane finish. In other systems it may be desirable to add use a glass reinforcement in the greige state that does not have a finish or coupling agent applied to the glass fiber.

The refractive index (RI) of the fiber samples listed in Table I were measured with Transmitted Single Polarized Light (TSP) with a 20×/0.50 objective, and Transmitted Phase Contrast Zernike (PCZ) with a 20×/0.50 objective. The fiber samples were prepared for refractive index measurement by cutting portions of the fibers using a razor blade. The fibers were mounted in various RI oils on glass slides and covered with a glass coverslip. The samples were analyzed using the Zeiss Axioplan (Carl Zeiss, Germany). Calibration of the RI oils was performed on an ABBE-3L Refractometer, manufactured by Milton Roy Inc., Rochester, N.Y., and values were adjusted accordingly. The Becke Line Method accompanied with phase contrast was used to determine the RI of the samples. The nominal RI results for the values of n_{D}, the refractive index at the wavelength of the sodium D-line, 589 nm, had an accuracy of ±0.002 for each sample.

Summary information for various resins used in Examples 1-4 is provided in Table I.

TABLE I
Resin Components

| Component | | Resin | Refractive |
|---|---|---|---|
| ID | Manufacturer | Component | Index |
| C1 | Cytec Surface | Ebecryl 600 | 1.5553 |
| | Specialties | | |
| C2 | Sartomer Company | TMPTA (SR351) | 1.4723 |
| C3 | Ciba Specialty Chemicals | Darocur 1173 | 1.5286 |
| | Corp. | | |
| C4 | Cognis Corp. | Photomer 6210 | |
| C5 | Sartomer Company | THFA (SR285) | |
| C6 | Sartomer Company | HDODA(SR238) | |
| C7 | Ciba Specialty Chemicals | Darocur 4265 | |
| | Corp. | | |

Darocur 1173 and Darocur 4265 are photoinitiators, while THFA (tetrahydrofurfuryl acrylate) is a mono-functional acrylate monomer. The remaining components in Table I are cross-linkable resins. Ebecryl 600 is a Bisphenol-A epoxy diacrylate oligomer.

### Example 1

### Monolithic Brightness Enhancing Composite Layer

The raw materials used for the polymer resin in this example were:

| Component | Wt. % |
|---|---|
| C1 | 69.3 |
| C2 | 29.7 |
| C3 | 1.0 |

The fiber reinforcement was a Hexcel Style 106 woven fiber fabric with a CS767 finish. The refractive index of the fibers is 1.551±0.002. The refractive index of the cured composite resin mixture used here and in all of the following examples (69.3/29.7/1.0 Ebecryl 600/TMPTA/Darocur 1173) is 1.5517. Therefore, the refractive index difference between the polymer matrix and the fiber is around 0.0007.

The preparation of the monolithic composite started by taping a 12″×24″ (30 cm×60 cm) sheet of PET to the leading edge of a 12″×20″×¼″ (30.5 cm×50.8 cm×0.6 cm) sheet of aluminum. A molding tool for producing a prismatic brightness enhancing structure was laid on top of the PET and a sheet of fiberglass fabric was laid on top the molding tool. The molding tool was designed to produce an undulating prismatic brightness enhancing surface like that used in Vikuiti™ BEF-III film, having a prism pitch of 50 μm and an apex angle of 90°.

The fiberglass fabric was covered by another sheet of 12″×24″ (30 cm×60 cm) PET and its leading edge was taped to the leading edge of the aluminum plate. The leading edge of the aluminum plate was placed into a hand-operated laminator. The top sheet of PET and the fiberglass were peeled backwards to allow access to the molding tool. A bead of resin (8-10 mL) was applied to the molding tool, near the edge closest to the laminating rolls. The sandwich construction was fed through the laminator at a steady rate forcing the resin up through the fiberglass fabric, coating the fabric entirely.

The laminate, still attached to the aluminum plate, was placed in a vacuum oven and heated to a temperature between 60° C. and 65° C. The oven was evacuated to 27 inches (68.6 cm) of Hg below atmospheric pressure and the laminate was degassed for four minutes. The vacuum was released by introducing nitrogen into the oven. The laminate was passed through the laminator once more.

The resin was cured by passing the laminate beneath a Fusion “D” UV lamp operating at 600 W/in (236 W/cm) at a speed of 30 fpm (15 cm/s). The composite was removed from the tool by peeling a free edge back until the entire sheet had been extricated from the molding tool. The unprimed PET backing was also removed from the composite, leaving a ‘single-layer’ monolithic prismatic composite film.

### Example 2

### Monolithic Brightness Enhancing Composite Film on Reflecting Polarizer

A monolithic composite like described in Example 1 was formed on the surface of a primed multilayer reflective polarizer (RP) similar to 3M Vikuiti™ DBEF-P2. A second composite layer having flat sides was placed on the other side of the polarizer layer for mechanical support. In this example, a laminating adhesive was used to join the polarizer layer to the composite layers. Thus, the final structure had the following layers, from top to bottom: transparent composite with prismatic surface/laminating adhesive/RP/laminating adhesive/transparent composite. This structure was similar to that depicted in FIG. 7.

The laminating resin was formed as follows:

| Component | Wt. % |
|---|---|
| C4 | 64.4 |
| C5 | 24.7 |
| C6 | 9.9 |
| C7 | 1.0 |

A primer was used to improve the adhesion of the acrylate resin to both sides of the RP layer. The primer was a mixture of hexanediol diacrylate 97% (w/w) and benzophenone 3% (w/w). For priming sheets of film, three drops of the solution were applied to the necessary side of the film and coated using a tissue by wiping. The excess primer solution may be removed by wiping with a clean tissue. The coating is cured using a Fusion “D” UV lamp operating at 600 W/in (236 W/cm) at a line speed of 30 fpm (15 cm/s) in an air atmosphere. The primed sheet of RP was subsequently attached to a pre-made transparent composite by coating and curing the laminating adhesive between the RP and the composite.

The preparation procedure for the structured surface composite was the same as for Example 1. In addition, the flat transparent composite was formed in the following manner. A 12″×24″ (30 cm×60 cm) sheet of PET was taped to the leading edge of a 12″×20″×¼″ (30.5 cm×50.8 cm×0.6 cm) sheet of aluminum. A sheet of Hexcel 106 fiberglass fabric was laid on top the PET. The fiberglass fabric was covered by another sheet of 12″×24″ (30 cm×60 cm) PET and its leading edge was taped to the leading edge of the aluminum plate. The leading edge of the aluminum plate was placed into a hand operated laminator. The top sheet of PET and the fiberglass fabric were peeled backwards to allow access to the bottom sheet of PET. A bead of resin (6-8 mL) was applied to the bottom sheet of PET near the edge closest to the laminating rolls. The sandwich construction was fed through the laminator at a steady rate forcing the resin up through the fiberglass fabric.

The laminate, still attached to the aluminum plate, was placed in a vacuum oven and heated to a temperature between 60° C. and 65° C. The oven was evacuated to 27 inches (68.6 cm) of Hg below atmospheric pressure and the laminate degassed for four minutes. The vacuum was released by introducing nitrogen into the oven. The laminate was passed through the laminator once again. The resin was cured by passing the laminate beneath a Fusion “D” or Fusion “H” UV lamp operating at 600 W/in (236 W/cm) at a speed of 30 fpm (15 cm/s).

The attachment of the transparent composite to the primed RP layer began by taping a 12″×24″ (30 cm×60 cm) sheet of PET to the leading edge of a 12″×20″×¼ (30.5 cm×50.8 cm×0.6 cm) sheet of aluminum. A primed sheet of RP was laid on the PET. The bottom sheet of PET was carefully stripped away from the pre-made transparent composite layer. The pre-made transparent composite layer was laid, composite side down, on top of the RP layer. The top PET layer of the composite was taped to the leading edge of the aluminum plate. The leading edge of the aluminum plate was placed into a hand operated laminator. The top sheet of composite/PET was pulled backwards to allow access to the sheet of RP. A bead of the laminating adhesive resin (˜5 mL) was applied to the edge of the RP closest to the laminating rolls. The sandwich construction was fed through the laminator at a steady rate, coating both the RP and pre-made composite layer with the laminating resin.

The laminate, still attached to the aluminum plate, was cured by passing the laminate beneath a Fusion “D” UV lamp operating at 600 W/in (236 W/cm) at a speed of 30 fpm (15 cm/s).

The monolithic brightness enhancing composite film was attached to the RP/transparent composite using a procedure like that used to attach the RP to the flat transparent composite.

### Example 3

### Monolithic Composite with Diffractive Surface

A transparent fiberglass composite was formed with a diffractive microstructured surface on a polyimide molding tool. The article thus comprises a single composite layer with a diffractive structured surface. The sample was prepared in the same manner as described above for Example 1, except that the molding tool provided a diffractive structure on the layer. Also, a release coating was applied to the molding tool prior to the first use to aid the removal of the cured composite from the molding tool.

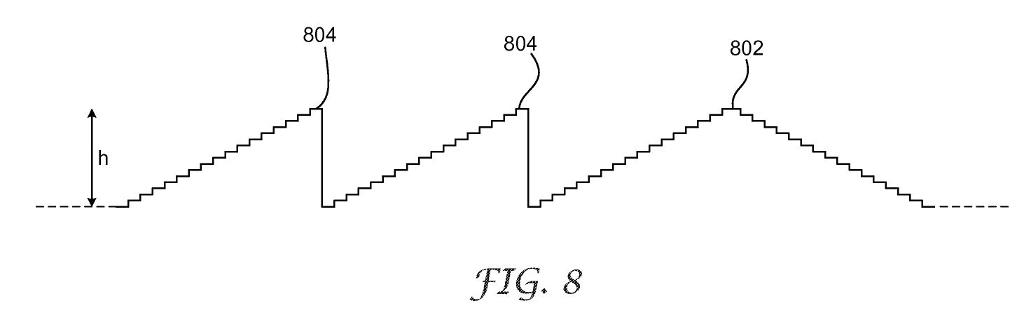

The diffraction pattern was square zone plate with one millimeter squares, seventeen zones and sixteen levels, designed to work at 632 nm, with a focal length of 1 cm. A partial cross-section of the photopolymerized “positive image” is schematically represented in FIG. 8. The figure shows three of the seventeen zones, a central zone 802 and two side zones 804. The maximum height, h, of each zone reached to 632 nm. The diffractive structure functions as a positive lens.

### Example 4

### Monolithic Composite with Lenslet Surface

A transparent fiberglass composite was formed with a lenslet microstructured surface. The sample preparation procedure for Example 4 was the same as for Example 1, except that the molding tool was one designed to produce a lenslet array. The procedure included the act of coating and curing the fiberglass on the lenslet microstructured surface tool. Also, a release coating was applied to the molding tool prior to the first use to aid the removal of the cured composite from the tool.

The lenslet structure includes an array of positive lenses, 75 microns across, with a 30 micron sag.

Optical Measurements

The relative gain performance of the BEF-like composite examples, Examples 1 and 2, was measured using a SpectraScan™ PR-650 SpectraColorimeter with an MS-75 lens, available from Photo Research, Inc, Chatsworth, Calif. These values were compared to existing products used as comparative examples. The comparative examples included Vikuiti™ Thin-BEF-II, BEF-III-10-T, BEF-RP, and DBEF-DTV, commercially available from 3M Company, St. Paul Minn. Thin-BEF-II has a pattern of prisms having a 90° apex angle and 24 μm height on a 2 mil (50 μm) PET substrate. This pattern is referred to as a 90/24 pattern. BEF-III-10-T has a pattern of prisms having a 90° apex angle and a 50 μm height on a 10 mil PET substrate. BEF-RP has a 90/24 prism pattern on a reflective polarizing substrate, DBEF-Q. DBEF-DTV has prisms with a rounded apex having a 7 μm radius on a 10 mil polycarbonate (PC) substrate laminated to DBEF-Q having a hazy PC backing. The cured prism resin indices for all of these films are ˜1.58, the PET average index is ˜1.66, and the PC average index is ˜1.58.

The general relative gain test method used to quantify the optical performance of the inventive optical films is now described. Although specific details are given for completeness, it should be readily recognized that similar results can be obtained using modifications of the following approach. Optical performance of the films was measured using a SpectraScan™ PR-650 SpectraColorimeter with an MS-75 lens, available from Photo Research, Inc, Chatsworth, Calif. The films were placed on top of a diffusely transmissive hollow light box. The diffuse transmission and reflection of the light box can be described as Lambertian. The light box was a six-sided hollow cube measuring approximately 12.5 cm×12.5 cm×11.5 cm (L×W×H) made from diffuse PTFE plates of ˜6 mm thickness. One face of the box is chosen as the sample surface. The hollow light box had a diffuse reflectance of ˜0.83 measured at the sample surface (e.g. ˜83%, averaged over the 400-700 nm wavelength range, box reflectance measurement method described further below). During the gain test, the box is illuminated from within through a ˜1 cm circular hole in the bottom of the box (opposite the sample surface, with the light directed towards the sample surface from the inside). This illumination is provided using a stabilized broadband incandescent light source attached to a fiber-optic bundle used to direct the light (Fostec DCR-II with ˜1 cm diam. fiber bundle extension from Schott-Fostec LLC, Marlborough Mass. and Auburn, N.Y.). A standard linear absorbing polarizer (such as Melles Griot 03 FPG 007) is placed between the sample box and the camera. The camera is focused on the sample surface of the light box at a distance of ˜34 cm and the absorbing polarizer is placed ˜2.5 cm from the camera lens. The luminance of the illuminated light box, measured with the polarizer in place and no sample films, was >150 cd/m². The sample luminance is measured with the PR-650 at normal incidence to the plane of the box sample surface when the sample films are placed parallel to the box sample surface, the sample films being in general contact with the box. The relative gain is calculated by comparing this sample luminance to the luminance measured in the same fashion from the light box alone. The entire measurement was carried out in a black enclosure to eliminate stray light sources. When the relative gain of film assemblies containing reflective polarizers was tested, the pass axis of the reflective polarizer was aligned with the pass axis of the absorbing polarizer of the test system.

The diffuse reflectance of the light box was measured using a 15.25 cm (6 inch) diameter Spectralon-coated integrating sphere, a stabilized broadband halogen light source, and a power supply for the light source all supplied by Labsphere (Sutton, N.H.). The integrating sphere had three opening ports, one port for the input light (of 2.5 cm diameter), one at 90 degrees along a second axis as the detector port (of 2.5 cm diameter), and the third at 90 degrees along a third axis (i.e. orthogonal to the first two axes) as the sample port (of 5 cm diameter). A PR-650 Spectracolorimeter (same as above) was focused on the detector port at a distance of ˜38 cm. The reflective efficiency of the integrating sphere was calculated using a calibrated reflectance standard from Labsphere having ˜99% diffuse reflectance (SRT-99-050). The standard was calibrated by Labsphere and traceable to a NIST standard (SRS-99-020-REFL-51). The reflective efficiency of the integrating sphere was calculated as follows:
Sphere brightness ratio=1/(1−Rₛₚₕₑᵣₑ*R_{standard})
The sphere brightness ratio in this case is the ratio of the luminance measured at the detector port with the reference sample covering the sample port divided by the luminance measured at the detector port with no sample covering the sample port. Knowing this brightness ratio and the reflectance of the calibrated standard (R_{standard}), the reflective efficiency of the integrating sphere, Rₛₚₕₑᵣₑ, can be calculated. This value is then used again in a similar equation to measure a sample's reflectance, in this case the PTFE light box:
Sphere brightness ratio=1/(1−Rₛₚₕₑᵣₑ*Rₛₐₘₚₗₑ)
Here the sphere brightness ratio is measured as the ratio of the luminance at the detector with the sample at the sample port divided by the luminance measured without the sample. Since Rₛₚₕₑᵣₑ is known from above, it is straightforward to calculate Rₛₐₘₚₗₑ. These reflectances were calculated at 4 nm wavelength intervals and reported as averages over the 400-700 nm wavelength range.

The CIE (1931) chromaticity coordinates of the sample/light box assembly are simultaneously recorded by the PR-650. These chromaticity coordinates give a quantitative measure of color differences between samples. The relative gain is calculated by comparing the sample luminance to the luminance measured in the same fashion from the light box alone, that is, the relative gain is equal to the ratio of the luminance measured with a film over the luminance measured without the film, i.e. the gain, g, is given by the expression:
g=L_{f}/Lₒ,

where L_{f} is the measured luminance with the film in place and Lₒ is the measured luminance without the film.

The measurements were carried out in a black enclosure to eliminate stray light sources. When the relative gain of film assemblies containing reflective polarizers was tested, the pass axis of the reflective polarizer was aligned with the pass axis of the absorbing polarizer of the test system. The ‘blank’ luminance measured from the light box alone, with the absorbing polarizer of the test system in place and no samples above the light box, was ˜275 candelas/sq. meter.

The variability of the gain measurement itself is quite low (˜1%). However there are several potential sources of sample variability, including varying haze levels and prism geometries in the comparative examples and the possible presence of air bubbles in sections of the inventive samples. An additional factor that should be considered when evaluating Ex. 2 is that the prisms of Ex. 2 are aligned perpendicular to the pass axis of the RP layer of Ex. 2. This is a preferred orientation when Ex. 2 is used alone, but may not be preferred in some film assemblies (depending on the assembly). The comparative examples BEF-RP and DBEF-DTV have the opposite prism orientation, not because it is optically preferable but because it is preferred for manufacturing efficiency. In some embodiments of the invention the brightness gain is greater than 10%, in other embodiments greater than 50% and in other embodiments greater than 100%.

Table II shows the results of examples 1-4, the comparative examples, and the light box alone, without any film. In general, the relative gains of the composite examples are comparable to the corresponding comparative examples and no major color changes are evident. It is worth noting the very small differences in gain between, for instance, Example 1, Thin-BEF-II-T, and BEF-III-10-T. This indicates that the Example 1 structured composite has very low light absorption and scattering, which is critical for recycling optical film applications such as these. It is also of interest to note that Ex. 1 has comparable gain to Thin BEF-II-T and BEF-III-10-T despite the fact that the prism refractive index of Ex. 1 is lower than the comparative examples, because the Ex. 1 resin was designed to match the (lower) refractive index of the glass fiber reinforcements.

TABLE II
Thickness, Relative Gain, and Chromaticity for Examples 1-4 and
comparative products.

| | Thickness | Relative | | |
|---|---|---|---|---|
| Sample | (μm) | gain, g | x | y |
| Example 1 | 86 | 1.571 | 0.4736 | 0.4257 |
| Example 2 | 274 | 2.405 | 0.4711 | 0.427 |
| Example 3 | 85 | 1.302 | 0.475 | 0.4256 |
| Example 4 | 42 | 1.034 | 0.4754 | 0.4254 |
| Thin BEF-II-T | 63 | 1.587 | 0.4735 | 0.4271 |
| BEF-III-10-T | 277 | 1.608 | 0.4744 | 0.426 |
| BEF-RP | 152 | 2.416 | 0.4735 | 0.4271 |
| DBEF-DTV | 638 | 2.117 | 0.4716 | 0.4265 |
| Light box | — | 1.000 | 0.4755 | 0.4252 |

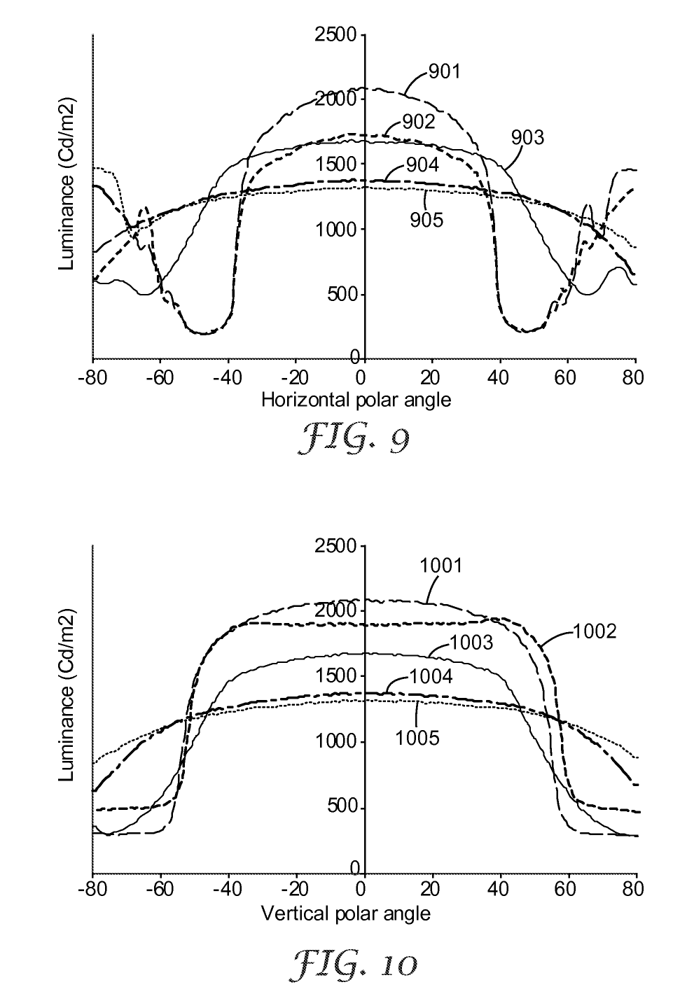

The angular outputs of the structured composite examples were measured by placing the sample films on an illuminated light box, descried below. The luminance vs. output angle was measured using an Autronic conoscope made by Autronic-Melchers GmbH, Karlsruhe, Germany. The measured results for each of the composite films is shown in FIGS. 9 and 10. FIG. 9 shows the luminance as a function of horizontal angle for the four examples, compared to the light box alone. Curve 901 corresponds to Example 1, curve 902 to Example 2, curve 903 to example 3, curve 904 to example 4 and curve 905 to the light box alone. FIG. 10 shows the luminance as a function of vertical angle for the four examples, compared to the light box alone. Curve 1001 corresponds to Example 1, curve 1002 to Example 2, curve 1003 to example 3, curve 1004 to example 4 and curve 1005 to the light box alone. The output of the light box alone is close to Lambertian. The light-directing films modify the output intensity vs. angle, for example re-directing a substantial portion of the light intensity towards a zero degree output, or normal to the face of the box. This increase in on-axis luminance is referred to as gain.

Other measurements, such as analyzing the angular output of initially collimated light, would further characterize the performance of the e.g. diffractive surfaces. The general performance of diffractive and lenslet structured surfaces is well known in the art and the composite examples described here should perform accordingly.

A test that is commonly used to characterize the performance of optical films is single-pass transmission. This type of transmission measurement does not take into consideration the effect of the film in a light-recycling cavity. Light that strikes the detector in this test has passed through the film only once. Further, the input light is typically directed at an angle that is substantially normal to the plane of the film, and all transmitted light is collected in an integrating sphere regardless of transmission angle. Many common devices test this type of single-pass transmission, including most commercially available haze-meters and UV-Vis spectrometers.

Many efficient brightness-enhancing films and light-redirecting films do not have high single-pass transmission. In particular, when the brightness enhancing structure is directed away from the light source, most brightness enhancing films have low single-pass transmission. This is because the brightness enhancing films are designed to efficiently create brightness enhancement in a recycling backlight by re-directing off-axis light towards the normal while recycling, through retroreflection, the on-axis light that is measured in single pass transmission. The net effect is efficient brightness enhancement in a display system. Thus, when combined with other characterization tests such as the relative gain test, single pass transmission can be used to evaluate the light-recycling efficiency of a prismatic brightness enhancing film. It is, therefore, desirable that brightness enhancing films show low values of single pass transmission values, when interpreted together with other measures, since they indicate high efficiency of retroreflection. High single pass transmission for certain brightness enhancing films is undesirable because it indicates irregularity and light scattering, leading to less efficient brightness enhancement in the completed display system. In some embodiments it is desirable to have a single pass transmission less than 40%, and in other embodiments less than 10%.

Exemplary optical films of the present invention were tested for single-pass transmission (% T) using a Perkin Elmer Lambda 900 UV-Vis Spectrometer (using an approximate average from 450-650 nm). The brightness enhancing structure was located on the side of the film directed away from the light source. Results are shown in Table III below.

TABLE III
Average single-pass transmission from 450-650 nm wavelength

| | Ave. % T (single |
|---|---|
| Example | pass) |
| Ex. 1 Monolithic BEF | 4.4 |
| Composite | |
| BEF-III-10-T Control | 6.7 |
| Thin BEF-II-T Control | 7.9 |

As can be seen, the composite brightness enhancing film showed a very low single pass transmission, indicative of high efficiency brightness enhancement in a display system.

The retardance of Example 1 was measured using an Axometrics Polarimeter with a spectral scanning source. The retardance was compared to some of the previous comparative examples, as well as an additional comparative example (PC-BEF, 7 μm radius prisms in BEF-III 90/50 pattern on a ˜250 μm thick polycarbonate substrate). The results are shown below in Table IV. In order to accurately measure the prismatic structures using this instrument, two techniques were used. The first technique employed an index-matching fluid to ‘wet-out’ the prism structures, allowing light to pass through the film to the detector. The second technique was to place two prism films in a stack with prisms facing one another, optically coupling them by placing water in between the films. Acceptable reproducibility was found between the two techniques. Variability on the order of 20-30% of the measured value may be expected in this test (some variability at low retardance levels is indicated in the ‘blank’ measurement below). The composite samples were found to have low retardance and low birefringence. The retardance (in nanometers) is defined here as d x (|nₒ−nₑ|), where d is the thickness of the sample, and the quantity (|nₒ−nₑ|) is equivalent to the birefringence or the magnitude of the index difference between the ordinary and extraordinary axes of the sample. Composite layers corresponding to those made here were found to have retardance values below 2 nm (at 600 nm wavelength), corresponding to birefringence values below 0.0001.

TABLE IV
Measured retardance values for Ex. 1 and comparative examples.

| | Retardance | | |
|---|---|---|---|
| | @ 600 nm | Thickness | Birefringence |
| Sample | (nm) | (um) | @ 600 nm |
| Example 1 BEF-III Composite | 1.65 | 86 | 0.00002 |
| Thin BEF-II-T | 1350 | 61 | 0.0221 |
| PC-BEF 7 um rounded | 8.8 | 268 | 0.00003 |
| BEF-III-10-T | 9000 | 276 | 0.0326 |
| Blank (Air) | 0.1-1.1 | — | — |

For certain surface structured films, especially brightness enhancing films, it is often desirable to limit the bulk diffusion that occurs within the film. Bulk diffusion is defined as the light scattering that takes place within the interior of an optical body (as opposed to light scattering occurring at the surface of the body). Bulk diffusion of a structured surface material can be measured by wetting out the structured surface using index matching oils and measuring the haze using a standard haze-meter. Haze can be measured by many commercially available haze-meters and can be defined according to ASTM D1003. Limiting the bulk diffusion typically allows the structured surface to operate most efficiently in re-directing light, brightness enhancement, etc. For some embodiments of the current invention, it is preferred that bulk diffusion is low. In particular, in some embodiments the haze may be less than 30%, in other embodiment less than 10% and in other embodiments less than 1%.

Bulk diffusion for Example 1 and certain other film samples was measured by wetting out the structured surfaces using certified refractive index matching oils made by Cargille (Series RF, Cat. 18005) and wetting out the films against a glass plate. The wet-out films and the glass plate were then placed in the light path of a BYK Gardner Haze-Gard Plus (Cat. No. 4725) and the haze recorded. In this case, the haze is defined as the fraction of light transmitted that is scattered outside an 8° cone divided by the total amount of light transmitted. The light is normally incident on the film.

The measured values of bulk haze, i.e. the haze arising from propagation within the bulk of the polymer matrix, rather than from any diffusion occurring at the surface of the film, are shown below in Table V. The film of Example 1 was wet-out using an oil having refractive index of 1.55. All other prism samples were wet-out using oils of index 1.58.

TABLE V
Bulk Haze Measurements

| | Haze (due to bulk |
|---|---|
| Sample | diffusion) % |
| Ex. 1 Monolithic BEF-III Composite | 0.57 |
| Thin BEF-II-T | 0.49 |
| BEF-III-10-T | 0.94 |
| Blank (Glass plate only) | 0.2 |

Mechanical Testing

The glass transition temperature of a film sample was measured using a TA Instruments Q800 series Dynamic Mechanical Analyzer (DMA) with film tension geometry. Temperature sweep experiments were performed in dynamic strain mode over the range of −40° C. up to 200° C. at 2° C./min. The storage modulus and tan delta (loss factor) were reported as a function of temperature. The peak of the tan delta curve was used to identify the glass transition temperature, T_{g}, for the films. The T_{g} was measured on a composite layer very similar to that used in Example 1 and produced a value of 71° C. The measured T_{g} on a corresponding sample of the same resin (with no reinforcement) was 90° C. Variability is due to measurement factors. The resin materials used for the composite layers had substantially the same T_{g} for all of the examples described here. In some embodiments it may be desirable for the value of T_{g} to be less than 120° C.

The storage modulus and stiffness (in tension) were measured with Dynamic Mechanical Analysis (DMA) using a TA instruments model# Q800 DMA with film tension geometry. Terminology relating to DMA testing can be defined according to ASTM D-4065 and ASTM D-4092. Reported values are at room temperature (24° C.). The stiffness results are summarized in Table VI. The measurements were made at a temperature in the range 24° C.-28° C. The table shows the marked increase in storage modulus which can be obtained using the composite materials. Storage modulus is of greater importance because it provides a thickness-independent measure of the film properties. Some variability in these data is to be expected both from the test method and the lab-scale prototyping of the composite samples.

These high values of tensile modulus and stiffness can be considered to correspond to potential bending stiffness as well, depending on final article construction and geometry: proper placement of the high-modulus layers results in an article having high bending stiffness. Higher stiffness enables ease of handling, thinner and lighter displays, and better display uniformity (through less warp or bending of optical components of the display). The actual performance of the final article will depend on the arrangement of the fibers and the final geometry of the article. For example, it is often desirable to construct ‘balanced’ articles, e.g. where there is either a single central composite layer or two symmetrically opposed composite layers, so that the material will not have a tendency to bend or curl in a given direction upon curing or heating. The composite samples tested here are substantially balanced in their construction.

Table VI lists the sample number along with a brief description of the sample. The table also lists the orientation of the measurements relative to the pass or block axes of the polarizer, or to the direction relative to the web as is manufactured on a machine. The direction “machine” corresponds to the down-web direction while the direction “transverse” corresponds to the direction across the web. The table also lists the average storage modulus, the average stiffness, and the thickness, T. The thickness was measured using an EG-233 digital linear gauge made by Ono Sokki (Yokohama, Japan).

TABLE VI
Storage Modulus and Stiffness values measured for some
representative samples.

| | | Polarizer or | | Storage | |
|---|---|---|---|---|---|
| Ex. | | film | Stiffness | Modulus | T |
| No. | Brief Description | orientation | (10⁴ N/m) | (MPa) | (μm) |
| 2 | Reinforced Thin | pass | 48 | 5130 | 260 |
| | BEF/RP | | | | |
| — | BEF-RP control | pass | 9.9 | 2677 | 122 |
| — | DBEF-DTV control | pass | 48 | 2330 | 626 |
| 2 | Reinforced Thin | block | 46 | 4960 | 260 |
| | BEF/RP | | | | |
| — | BEF-RP control | block | 15.5 | 4171 | 122 |
| — | DBEF-DTV control | block | 53 | 2590 | 626 |
| 1 | Monolithic BEF | machine | 19 | 7590 | 82 |
| | composite | | | | |
| — | Thin BEF control | machine | 8.9 | 4512 | 62 |
| 1 | Monolithic BEF | transverse | 16.3 | 6643 | 82 |
| | composite | | | | |
| — | Thin BEF control | transverse | 10.7 | 5296 | 62 |

The coefficients of thermal expansion (CTE) were measured using standard thermal-mechanical analysis on a Perkin Elmer TMA 7. Terminology relating to standard TMA testing can be defined according to ASTM E-473 and ASTM E-11359-1. Temperature sweep experiments were performed in expansion mode over the range of 30° C. up to 110° C. at 10° C./min. The measured values of CTE are summarized in Table VII.

The composite samples generally exhibit similar or lower CTE than the comparative commercial examples. For some of the commercial polarizer samples, the CTE performance is very different when measured along the pass and block axes of the polarizer (due to the processing and molecular orientation of the polarizer). In these cases, it is particularly important and useful to lower the CTE along the high-CTE axis of the polarizer, even if the CTE is relatively unaffected along the other axis (e.g. it is desirable to lower the average CTE and/or move in the direction of equalizing the pass state and block state CTE's). This useful effect is demonstrated in the composite samples. These lower CTE's should contribute to reduced warping and improved optical uniformity in some display applications.

TABLE VII
Coefficient of thermal expansion (CTE) values measured for some
representative samples.

| | | | Avg. 2nd |
|---|---|---|---|
| | | Polarizer | heat CTE |
| Example # | Brief Description | orientation | (ppm/° C.) |
| 2 | BEF III/RP composite | pass | 48.1 |
| — | BEF-RP II control | pass | 92.3 |
| — | DBEF-DTV control | pass | 88.4 |
| 2 | BEF III/RP composite | block | 42.3 |
| — | BEF-RP II control | block | 39.5 |
| — | DBEF-DTV control | block | 80.1 |
| 1 | Monolithic BEF composite | pass | 25.6 |
| — | Thin BEF control | pass | 35.9 |
| 1 | Monolithic BEF composite | block | 25.6 |
| — | Thin BEF control | block | 31.9 |

Film Combinations/Assemblies

Spatially periodic patterns can sometimes create undesirable Moiré effects when combined with other periodic patterns at certain specific spatial frequencies and angular relationships. Thus, in some cases, it may be desirable to adjust the spacing, arrangement, or angular bias of the reinforcing fibers in order to minimize Moiré patterns created between multiple composite layers, between composite layers and any structured film surfaces (of the same or adjacent films), or between composite layers and any display system elements such as pixels, light-guide dot patterns, or LED sources. Also, in cases where the index matching of the reinforcing fibers is nearly perfect and the composite layers are nearly perfectly smooth, significant Moiré patterns should not occur.

It will be appreciated that composite optical articles as discussed above may be advantageously combined into assemblies, in much the same way that existing optical films are combined into assemblies. An example of an assembly is “crossed-BEF”, where two BEF films are placed adjacent one another such that their prism grooves are approximately orthogonal, with the prismatic surface of one film adjacent the non-prismatic surface of the other. It may be, therefore, advantageous to combine composite films with various other optical films to achieve a beneficial optical effect. The film examples listed here could also be combined with the film examples, such as those described in U.S. patent application Ser. No. 11/323,726. Some examples of these film assemblies include, but are not limited to:
1. Composite BEF (Ex. 1) crossed with composite BEF-RP (e.g. Ex. 2).
2. Unreinforced BEF crossed with composite BEF-RP (e.g. Ex. 2).
3. Composite BEF (Ex. 1) crossed with composite BEF (Ex. 1).
4. Unreinforced BEF crossed with composite BEF (Ex. 1).
5. Composite BEF (Ex. 1) crossed with composite BEF (Ex. 1) and combined with a reflective polarizer, either unreinforced, or as described in U.S. patent application Ser. No. 11/323,726.
6. Unreinforced BEF crossed with composite BEF (Ex. 1) and combined with a reflective polarizer, either unreinforced, or as described in U.S. patent application Ser. No. 11/323,726.
7. Composite BEF (Ex. 1) combined with a reflective polarizer, either unreinforced, or as described in U.S. patent application Ser. No. 11/323,726.

Several of these film combinations/assemblies were measured using the same relative gain test method described above. The results are shown in Table VIII below. In general, the relative gains of the composite examples are comparable to the corresponding comparative examples and only small color changes are evident. It is worth noting the very small differences in gain between, for example, crossed Example 1 films and crossed Thin-BEF-II-T films. This indicates that the composite substrate of Example 1 has very low light absorption and scattering, which is critical for optical film applications such as these in which the light is recycled within a reflecting cavity so as to extract as much light in the desired viewable state as possible. It is also of interest to note that Ex. 1 has comparable gain despite the fact that the prism refractive index of Ex. 1 is lower than the comparative examples, because the Ex. 1 resin was designed to match the (lower) refractive index of the glass fiber reinforcements. In addition, the low birefringence of Example 1 allows it to be placed above or below a reflective polarizer (BEF-RP in this case) with only a small change in total gain, while the gain drop from placing Thin-BEF on top of BEF-RP is larger.

TABLE VIII
Characteristics of Exemplary Film Assemblies

| Film | | | CIE | |
|---|---|---|---|---|
| combinations | | | Chromaticity | |
| Bottom Film | Top Film | Rel. gain, g | x | y |
| Ex. 1 | Ex. 1 | 2.408 | 0.4724 | 0.4267 |
| Thin BEF II | Thin BEF II | 2.405 | 0.4717 | 0.4262 |
| Thin BEF II | BEF-RP | 3.186 | 0.4727 | 0.4287 |
| BEF-RP | Thin BEF | 2.916 | 0.4728 | 0.4282 |
| Ex. 1 | Ex. 2 | 3.141 | 0.4712 | 0.4283 |
| Ex. 1 | BEF-RP | 3.146 | 0.4736 | 0.4291 |
| BEF-RP | Ex. 1 | 3.074 | 0.4732 | 0.4283 |
| None | None | 1.000 | 0.4744 | 0.4252 |

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical film, comprising:
a first layer comprising inorganic fibers embedded within a polymer matrix, the first layer having a first structured surface, wherein the first layer provides a brightness gain of at least 10% to light that propagates through the first layer.

2. An optical film as recited in claim 1, wherein the brightness gain is at least 50%.

3. An optical film as recited in claim 1, wherein the brightness gain is at least 100%.

4. An optical film as recited in claim 1, wherein light that propagates substantially perpendicularly through the first layer is subject to a bulk haze of less than 30%.

5. An optical film as recited in claim 1, further comprising at least one of inorganic nanoparticles, light diffusing particles or hollow particles embedded within the polymer matrix.

6. An optical film as recited in claim 1, wherein the first structured surface comprises a brightness enhancing layer surface.

7. An optical film as recited in claim 1, wherein the first structured surface comprises a plurality of prismatic ribs.

8. An optical film as recited in claim 1, wherein the first structured surface comprises a plurality of retroreflecting elements.

9. An optical film as recited in claim 1, wherein the first structured surface comprises one or more lenses.

10. An optical film as recited in claim 9, wherein the one or more lenses comprise at least one Fresnel lens.

11. An optical film as recited in claim 1, wherein the first structured surface comprises one of a diffractive surface and a light collecting surface.

12. An optical film as recited in claim 1, wherein the first layer has a second structured surface facing away from the first structured surface.

13. An optical film as recited in claim 12, wherein a pattern of the first structured surface is registered to a pattern of the second structured surface.

14. An optical film as recited in claim 1, further comprising a second layer attached to the first layer.

15. An optical film as recited in claim 14, wherein the second layer comprises one of a reflective layer, a transmissive layer, a diffusive layer and a layer having a second structured surface.

16. An optical film as recited in claim 14, wherein the second layer comprises a polarizer layer.

17. An optical film as recited in claim 16, wherein the polarizer layer comprises a reflective polarizer layer.

18. An optical film as recited in claim 16, wherein the polarizer layer comprises an absorbing polarizer layer.

19. An optical film as recited in claim 14, wherein the second layer is attached to the first structured surface.

20. An optical film as recited in claim 14, wherein the second layer is attached to a surface facing away from the first structured surface.

21. An optical film as recited in claim 14, further comprising a third layer attached to one of the first and second layers.

22. An optical film as recited in claim 21, wherein the third layer is attached to the second layer and the third layer comprises inorganic fibers embedded within a polymer matrix.

23. An optical film as recited in claim 1, wherein the polymer matrix comprises a thermosetting polymer.

24. An optical film as recited in claim 1, wherein the polymer matrix comprises a thermoplastic polymer.

25. An optical film as recited in claim 1, wherein the polymer matrix comprises a polymer having a value of T_{g} less than 120° C.

26. An optical film as recited in claim 1, wherein a single pass transmission through the film for light directed substantially normally a surface of the film facing away from the structured surface is less than 40%.

27. An optical film as recited in claim 26, wherein the single pass transmission is less than 10%.

28. An optical film as recited in claim 1, wherein light directed to the film, having a principal ray at an angle of more 30° to a film normal, is transmitted out of the film with the principal ray propagating at an angle of less than 25° to the film normal.

29. An optical film as recited in claim 1, wherein when light is incident on the optical film, the light having a principal ray propagating in a first direction when incident on the optical film, the light is transmitted out of the film with the principal ray propagating in a second direction different from the first direction by at least 5°.

30. An optical film, comprising:
a first layer comprising inorganic fibers embedded within a polymer matrix, the first layer having a first structured surface wherein the single pass transmission for light, substantially normally incident on a side of the first layer facing away from the first structured surface, is less than 40%.

31. An optical film as recited in claim 30, wherein the single pass transmission is less than 10%.

32. An optical film as recited in claim 30, wherein the single pass transmission is less than 5%.

33. An optical film as recited in claim 30, wherein light that propagates substantially perpendicularly through the first layer is subject to a bulk haze of less than 30%.

34. An optical film as recited in claim 30, further comprising at least one of inorganic nanoparticles, light diffusing particles or hollow particles embedded within the polymer matrix.

35. An optical film as recited in claim 30, wherein the first structured surface comprises a brightness enhancing layer surface.

36. An optical film as recited in claim 30, wherein the first structured surface comprises a plurality of prismatic ribs.

37. An optical film as recited in claim 30, wherein the first structured surface comprises a plurality of retroreflecting elements.

38. An optical film as recited in claim 30, wherein the first structured surface comprises one or more lenses.

39. An optical film as recited in claim 38, wherein the one or more lenses comprise at least one Fresnel lens.

40. An optical film as recited in claim 30, wherein the first structured surface comprises one of a diffractive surface and a light collecting surface.

41. An optical film as recited in claim 30, wherein the first layer has a second structured surface facing away from the first structured surface.

42. An optical film as recited in claim 41, wherein a pattern of the first structured surface is registered to a pattern of the second structured surface.

43. An optical film as recited in claim 30, further comprising a second layer attached to the first layer.

44. An optical film as recited in claim 43, wherein the second layer comprises one of a reflective layer, a transmissive layer, a diffusive layer and a layer having a structured surface.

45. An optical film as recited in claim 43, wherein the second layer comprises a polarizer layer.

46. An optical film as recited in claim 45, wherein the polarizer layer comprises a reflective polarizer layer.

47. An optical film as recited in claim 45, wherein the polarizer layer comprises an absorbing polarizer layer.

48. An optical film as recited in claim 43, wherein the second layer is attached to the first structured surface.

49. An optical film as recited in claim 43, wherein the second layer is attached to a surface facing away from the first structured surface.

50. An optical film as recited in claim 43, further comprising a third layer attached to one of the first and second layers

51. An optical film as recited in claim 50, wherein the third layer is attached to the second layer and the third layer comprises a polymer matrix having inorganic fibers embedded within a polymer matrix.

52. An optical film as recited in claim 30, wherein the polymer matrix comprises a thermosetting polymer.

53. An optical film as recited in claim 30, wherein the polymer matrix comprises a thermoplastic polymer.

54. An optical film as recited in claim 30, wherein the polymer matrix comprises a polymer having a value of T_{g} less than 120° C.

55. An optical film as recited in claim 30, wherein light directed to the film, having a principal ray at an angle of more 30° to a film normal, is transmitted out of the film with the principal ray propagating at an angle of less than 25° to the film normal.

56. An optical film as recited in claim 30, wherein when light is incident on the optical film, the light having a principal ray propagating in a first direction when incident on the optical film, the light is transmitted out of the film with the principal ray propagating in a second direction different from the first direction by at least 5°.

57. A display system, comprising:
a display unit;
a backlight; and
an optical film as recited in claim 1 disposed between the display unit and the backlight.

58. A display system, comprising:
a display unit;
a backlight; and
an optical film as recited in claim 30 disposed between the display unit and the backlight.
